(19) United States
(12) Patent Application Publication
(10) Pub. No.: US 2005/0260382 A1
(43) Pub. Date: Nov. 24, 2005

(54) Two-shot polymeric vehicle trim component and method of producing same

(75) Inventors: Michael P. Schoemann, Waterford, MI (US); Randy S. Reed, Fair Haven, MI (US); John D. Youngs, Southgate, MI (US); Glenn A. Cowelchuk, Chesterfield Township, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/852,059

(22) Filed: May 24, 2004

(51) Int. Cl. B32B 3/10; B29C 45/16

(52) U.S. Cl. 428/131; 264/255

(57) ABSTRACT

A method for producing a vehicle trim component including a two-shot polymeric closeout panel and a substrate having at least one opening therein is provided. A first portion of the closeout panel is injection molded. The first portion includes at least one cavity forming structure that is configured to cooperate with a corresponding opening in the substrate. This forms a corresponding cavity that is accessible through the substrate. A second portion of the closeout panel is injection molded, and covers at least some of the at least one cavity forming structure.

### BACKGROUND OF THE INVENTION

1. Field of the Invention

The present invention relates to a two-shot polymeric vehicle trim component, and a method of producing such a component.

2. Background Art

Polymeric materials are used today in an ever increasing number of different applications. Whether it is in a structural application, or one designed primarily for aesthetics, the use of polymeric materials often provides a light weight and less expensive alternative to materials such as metals. The use of polymeric materials in vehicles is one example. The interior of many vehicles contains a wide variety of polymeric components—e.g., door panels, instrument panels, consoles and pillar trim components, just to name few. Some components, such as door panels and consoles, may provide a vehicle occupant with a storage space, such as a map pocket or coin tray. In some cases, the door panel or console is formed from two main components: a substrate and a closeout panel. Typically, the substrate forms the portion of the vehicle trim component that will face the interior of the vehicle, and hence, will be viewed by vehicle occupants.

To form a storage space, such as a map pocket or coin tray, the substrate is molded with one or more openings that will provide to a vehicle occupant access to an area behind the substrate. Attached to the back of the substrate—i.e., the side away from the vehicle interior—is the closeout panel. The closeout panel is configured to form the sidewalls, back wall, bottom, etc. of the storage space. Thus, when the substrate and closeout panel are assembled, a vehicle occupant may reach through the opening in the substrate to place objects in the pocket or tray formed by the closeout panel.

In many cases, it is desirable to provide a material for the closeout panel that is different from the material used for the substrate. Thus, the substrate may be made from a relatively hard polymer, while the closeout is made from a relatively soft polymer, or even a different material such as cloth. Even if the closeout is made from the same material as the substrate, it may be desirable to provide a closeout in a different color than the substrate. In either case, the closeout and substrate are molded, or otherwise manufactured, in separate steps, then brought together later to be assembled into the final trim component.

One such vehicle trim component is described in U.S. Pat. No. 6,210,613 issued to Stein et al. on Apr. 3, 2001. Stein et al. describes a method of making a door trim panel assembly. The door trim panel assembly may include one or more components, such as a map pocket closeout. To form the door trim panel assembly, Stein et al. describes a method that includes injection molding a door trim substrate, and then placing the substrate into a second mold. The map pocket closeout may be pre-joined to the substrate with an adhesive before the substrate is placed into the mold, or alternatively, the map pocket closeout may be separately placed into the mold adjacent the substrate. A polymeric material is then introduced into the mold to create the door trim panel assembly. One limitation of the method taught by Stein et al. is that it requires multiple steps, including the use of multiple molds. The substrate and closeout are separately formed, and then must be brought together in a single mold for final assembly. Such a method requires many individual steps, and even multiple workstations, all of which increase cycle time and add to labor cost.

Because the closeout will often be made from a different material, or at least a different colored material, it has not been practical to form the closeout and the substrate together in a single molding operation. Of course, a closeout may be formed from the same material as the substrate, but then it is desirable to cover the closeout with a second material prior to assembly with the substrate. Thus, secondary operations are still required even if the closeout is molded along with the substrate.

Therefore, a need exists for a vehicle trim component having a substrate and a closeout that can be formed together in the same mold, such that the closeout and substrate can be assembled without the need for secondary operations to apply a different material to the closeout prior to assembly.

### SUMMARY OF THE INVENTION

Accordingly, the present invention provides a vehicle trim component having a substrate and a closeout that are formed in a single mold, such that secondary operations to add material to the closeout prior to its assembly with the substrate are not required.

The invention also provides a method for producing a vehicle trim component including a two-shot polymeric closeout panel and a substrate having at least one opening therein. The method includes injection molding a first portion of the closeout panel, including at least one cavity forming structure configured to cooperate with a corresponding opening in the substrate, thereby forming a corresponding cavity that is accessible through the substrate. A second portion of the closeout panel is injection molded, and covers at least some of the at least one cavity forming structure.

The invention further provides a method for producing a vehicle door panel including a two-shot polymeric closeout panel and a substrate having at least one opening therein. The method includes injection molding a first portion of the closeout panel, including at least one cavity forming structure configured to cooperate with a corresponding opening in the substrate, thereby forming a corresponding cavity that is accessible through the substrate. A second portion of the closeout panel is injection molded, and covers at least some of the at least one cavity forming structure.

The invention also provides a two-shot polymeric vehicle trim component, that includes a substrate including at least one opening therein. A closeout panel includes first and second portions, and is configured to cooperate with the substrate to form the trim component. The first portion includes at least one cavity forming structure configured to cooperate with a corresponding opening in the substrate, thereby forming a corresponding cavity that is accessible through the substrate. The second portion covers at least some of the at least one cavity forming structure.

### BRIEF DESCRIPTION OF THE DRAWINGS

FIG. 1 shows an exploded perspective view of a portion of a mold used to produce a vehicle trim component in accordance with the present invention;

FIG. 2 is a flowchart illustrating the steps of a method of producing a vehicle trim component in accordance with the present invention;

FIG. 3 shows a vehicle door panel produced by the method illustrated in FIG. 2;

FIG. 4 shows a closeout panel used in the trim component shown in FIG. 3; and

FIGS. 5A and 5B respectively show the first shot of a closeout panel and a substrate used to form the door panel shown in FIG. 3.

### DETAILED DESCRIPTION OF THE PREFERRED EMBODIMENT(S)

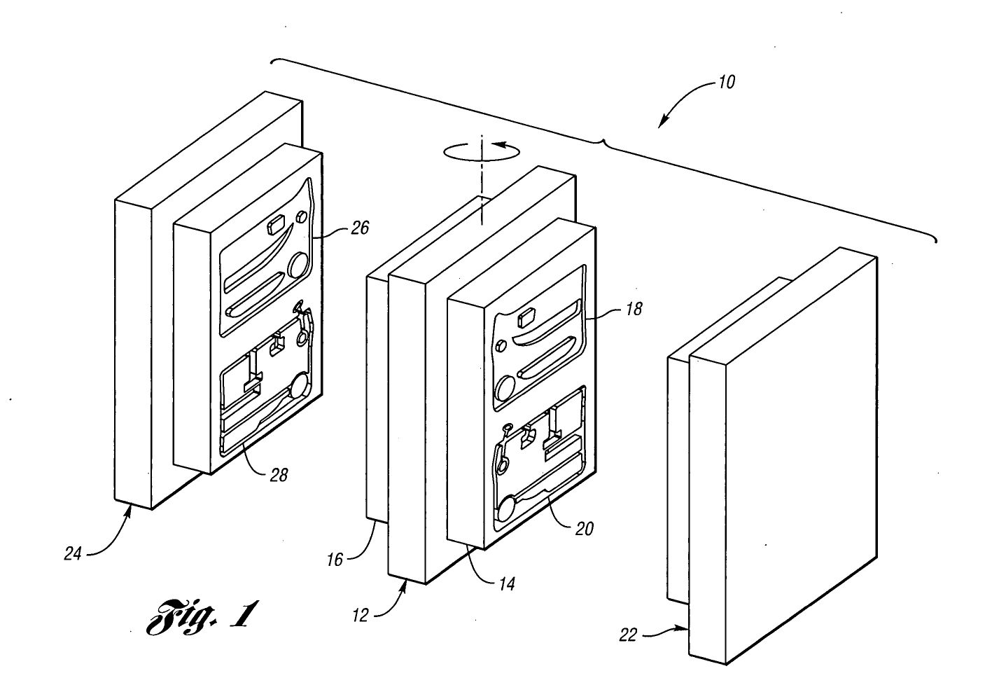

FIG. 1 shows portions of a mold 10 configured to produce a two-shot polymeric component in accordance with the present invention. The mold 10 includes a rotatable core 12 having first and second portions 14, 16. As shown in FIG. 1, the first portion 14 of the core 12 includes a pattern 18 configured to form a portion of a substrate of a vehicle trim component. The first portion 14 of the core 12 also includes a pattern 20, configured to form a portion of a closeout panel that will mate with the substrate to form the vehicle trim component. Because a mating substrate and closeout panel can both be formed in the mold 10, the mold 10 may generally be referred to as a “family tool”. Although they are not visible in FIG. 1, the second portion 16 of the core 12 also has patterns that match the patterns 18, 20 in the first portion 14. Such a configuration provides for an efficient production process that reduces cycle time.

The mold 10 also includes a first cavity 22 and a second cavity 24. Each of the cavities 22, 24 is configured to cooperate with either of the first and second portions 14, 16 of the core 12, to facilitate molding of a substrate and closeout panel for a vehicle trim component. As shown in FIG. 1, the second cavity 24 includes patterns 26, 28 that are configured to mate with respective patterns in the core 12. Similarly, the first cavity 22 has patterns (not visible) that also mate with respective patterns in the core 12. As explained more fully below, the first and second portions 14, 16 of the core 12 have matching patterns, while the first and second cavities 22, 24 have different patterns. This facilitates molding of a two-shot polymeric component.

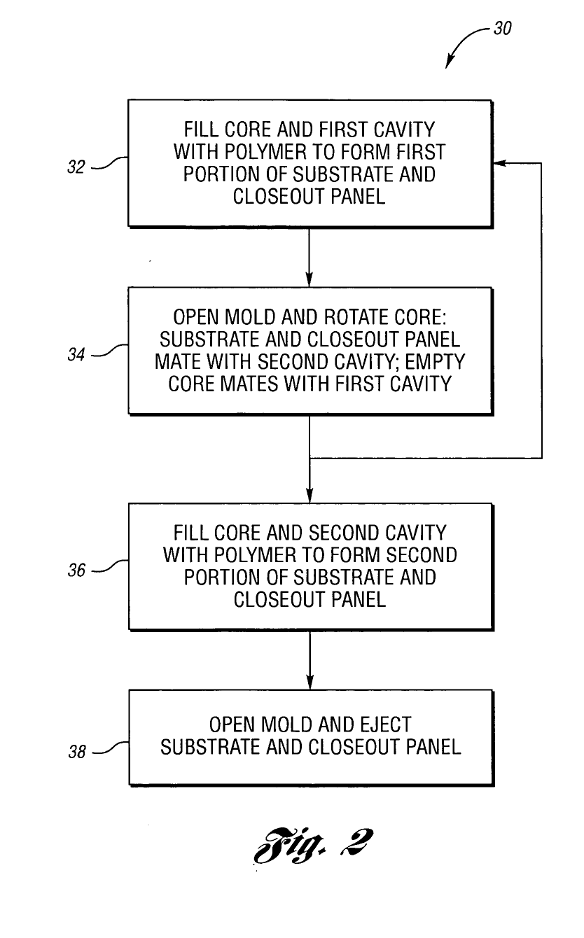

FIG. 2 shows a flowchart 30 illustrating a method in accordance with the present invention. To facilitate explanation of the steps in the flowchart 30, the mold 10, shown in FIG. 1, will be used for reference. It is understood, however, that various other mold configurations could be used to perform the method illustrated in FIG. 2. In step 32, the core 12 and the first cavity 22 are filled with a polymeric material to form a first portion of a substrate and a first portion of closeout panel. When complete, the substrate and the closeout panel will be assembled to form a vehicle trim component. In particular, the pattern 18 in the core 12 and its mating pattern (not visible) in the first cavity 22, will form a first portion of a vehicle trim substrate, while the pattern 20 and a corresponding pattern (also not shown) in the cavity 22 will form the first portion of a closeout panel.

At step 34, the mold 10 is opened and the core 12 is rotated. This is indicated by the directional arrow shown in FIG. 1. The first portion of the substrate and closeout panel that were molded with the first cavity 22, remain in the core 12. When the very first production part is molded, the second portion 16 of the core 12 will be empty; therefore, as the core 12 rotates to bring the first portion 14 in alignment with the second cavity 24, the empty second portion 16 of the core 12 is simultaneously brought into alignment with the first cavity 22. This means that a second portion of the newly formed substrate and closeout panel can be molded in the second cavity 24, while the first portion of another part is molded simultaneously in the first cavity 22.

This concept is illustrated in FIG. 2, where the flowchart 30 splits after step 34. One path leads to step 36, where the second cavity 24 and the core 12 are filed with a polymeric material to form the second portion of the substrate and closeout panel over the respective first portions previously formed in the first cavity. The other path leads to step 32, where the first portion of another substrate and another closeout panel are concurrently formed in the first cavity 22 and the core 12 while the second portions are formed in the second cavity 24 and the core 12. This type of production setup provides a highly efficient use of cycle time, so that after the first production part is molded, first and second portions of production parts can be molded simultaneously.

After steps 32 and 36 are concurrently performed, the next two steps are also concurrently performed. That is, at step 38, the mold 10 is opened and the completed substrate and closeout panel that were formed in the cavity 24 are ejected. At the same time, the core 12 is again rotated such that the first portion of the substrate and closeout panel just formed in the first cavity 22 are brought into alignment with the second cavity 24. Because the completed substrate and closeout panel have been ejected from the core 12, the portion of the core 12 now facing the first cavity 22 is again empty and ready to form another part. Thus, with the exception of the first production part and the last production part, first and second portions of a substrate and closeout panel can be formed concurrently using the mold configuration illustrated in FIG. 1.

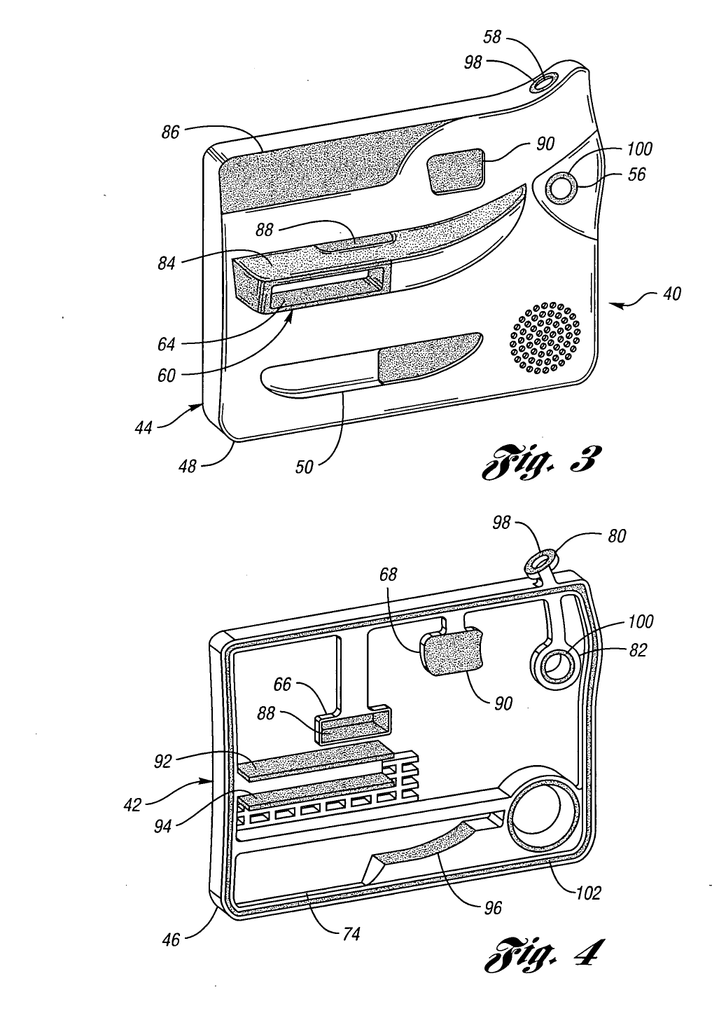

Turning now to FIG. 3, a vehicle trim component, and in particular an assembled vehicle door panel 40, is shown. A closeout panel 42—shown in FIG. 4, but not visible in FIG. 3—is configured to cooperate with a substrate 44 to form the door panel 40. A closeout panel and substrate, such as the closeout panel 42 and the substrate 44, can be attached to each other by any method effective to secure them together to form an assembled door panel. For example, fasteners, such as screws or the like, can be used, or the substrate and closeout panel can be welded together. In the case of a vehicle trim component that has air ducts, it may be necessary to vibration weld the entire perimeter of the closeout panel to the substrate to ensure an effective seal. As explained below, the two-shot process of the present invention can provide integral seals which allows greater flexibility in assembly. That is, a closeout panel having integrally molded seals may be sonic welded or even heat staked to a substrate, thereby saving time and labor over a more costly vibration welding process.

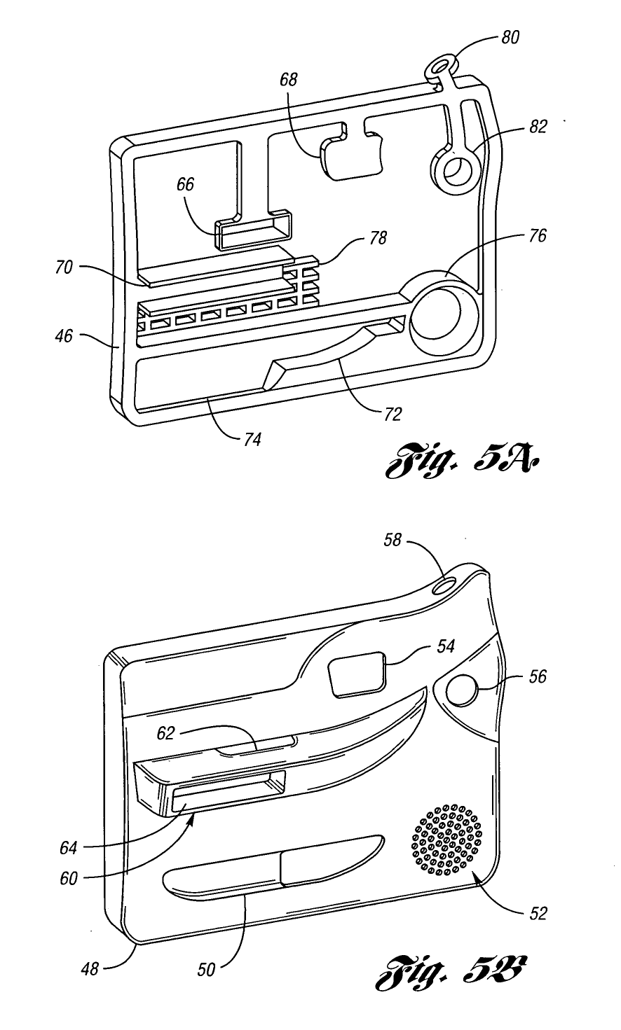

As discussed above, the closeout panel 42 and the substrate 44 are each made from two separate portions that are molded in a family tool. In particular, the closeout panel 42 and the substrate 44 are each made from a two-shot process which, in one embodiment, uses different polymeric materials for each shot. FIG. 5A shows a first portion, or first shot 46 of the closeout panel 42. Similarly, FIG. 5B shows a first portion, or first shot 48 of the substrate 44. Although the term “substrate” can be used to describe the respective first shots 46, 48 of the closeout panel 42 and the substrate 44, for clarity, the term “substrate” as used herein refers only to the component 44.

As shown in FIG. 5B, the first shot 48 of the substrate 44 has molded therein a number of openings, including a map pocket opening 50, a plurality of small audio speaker openings 52, a door latch opening 54 and two air duct openings 56, 58. Also molded into the first shot 48 of the substrate 44 is an armrest structure 60. The armrest structure 60 includes a pull cup 62 which may be used by a vehicle occupant to pull the door closed. Also included in the armrest structure 60 is a storage space 64. With reference to FIG. 1, the first shot 48 of the substrate 44, including the openings 50-58 and the armrest structure 60, are molded in the core 12 and the first cavity 22. The pattern 18 in the core 12 is a simplified schematic version of a pattern that may be used to produce a first shot, such as the first shot 48, of a door panel substrate.

FIG. 5A shows the first shot 46 of the closeout panel 42, including a number of features integrally molded therewith. For example, the first shot 46 includes a number of cavity forming structures such as a pull cup structure 66, a door latch structure 68, an armrest structure 70, a coin holder structure 72, a map pocket structure 74, and an audio speaker structure 76. Each of these various structures provides sidewalls and/or back or bottom walls to cooperate with a corresponding portion of the substrate 44. For example, the door latch structure 68 “closes out” the door latch opening 54. Similarly, the coin holder structure 72 and the map pocket structure 74 closeout the map pocket opening 50. Thus, various cavity forming structures in the closeout panel 42 cooperate with the substrate 44 to form cavities that are accessible through openings in the substrate.

Returning to FIG. 5A, the first portion 46 of the closeout panel 42 also includes an energy absorbing structure 78 and air ducts 80, 82. Each of these structures is also integrally molded with the first shot 46 when it is formed in the core 12 and first cavity 22—see FIG. 1. The air ducts 80, 82 may be connected to a portion of a vehicle heating, ventilation and air conditioning (HVAC) system. In particular, the air duct 80 may provide an airflow passage for a demister to keep the vehicle windows clear, while the air duct 82 may provide an airflow passage to an outlet in a vehicle instrument panel, to help regulate ambient air conditions within the vehicle.

The first shots 46, 48 can be made from any of a number of different polymeric materials, with the particular material chosen based on the application. For example, for the vehicle door panel 40, each of the first shots 46, 48 can be made from a relatively strong polymeric material, such as polypropylene (PP), acrylonitrile butadiene styrene (ABS), or polycarbonate ABS (PC-ABS). As discussed above, each of the first shots 46, 48 will have molded onto it a second portion, or second shot. In the embodiment shown in FIG. 3, each of the first shots 46, 48 are at least partly covered with a second shot, which is indicated by the various darkened lines and crosshatched areas described below. For example, the second shot of the substrate 44 includes a portion 84 disposed over the armrest structure 60 of the first shot 48. Similarly, another portion of the second shot of the substrate 44 forms a bolster 86. Bolsters are often made from a material that is different from the material used for the main door panel, and are therefore often added in a secondary operation. Using the two-shot molding process to provide the bolster 86 on the substrate 44 allows a different material to be used, without having to perform a secondary operation.

As shown in FIG. 4, the closeout panel 42 also has a second shot of material molded over the first shot 46 in a number of different locations. For example, the pull cup structure 66 and the door latch structure 68 each have a portion 88, 90 of the second shot respectively disposed over at least a portion of their surfaces. The portions 88, 90 of the second shot are also visible on the door panel 40—see FIG. 3—and are configured to provide aesthetic value to the vehicle as well as a pleasant contact surface for a vehicle occupant. Therefore, in the embodiment shown in FIGS. 3 and 4, a different material is used for the second shot than was used for the first shots 46, 48. For example, a relatively soft polymeric material may be used for the second shot, such as a thermoplastic elastomer (TPE), a thermoplastic polyolefin (TPO), or a thermoplastic vulcanizate (TPV).

As shown in FIG. 4, the second shot of the closeout panel 42 is also disposed over other portions of the first shot 46. For example, a portion 92 of the second shot is disposed over the armrest structure 70 to provide a cushion for a vehicle occupant using the armrest. Other portions 94, 96 of the second shot respectively provide a relatively soft surface for the armrest storage 64 and the coin holder 72. The portions 94, 96 of the second shot also provide a surface that keeps objects from sliding when the vehicle is in motion. In addition, such a surface helps to eliminate vehicle noises, commonly referred to as buzz, squeak and rattle (BSR) noises. This is because at least some of the portions of the second shot on the closeout panel 42 are located to contact the substrate 44 when it is assembled to the closeout panel 42. Of course, the locations of a second shot on a closeout panel, such as the closeout panel 42, may vary, depending on the application.

In addition to providing soft surfaces that help to address BSR issues, various portions of the second shot of the closeout panel 42 can be formed into seals to cooperate with the substrate 44 to form a seal between the substrate 44 and the closeout panel 42. For example, air ducts 80, 82 respectively have seals 98, 100 overmolded thereon. As shown in FIG. 3, the seals 98, 100 protrude through the air ducts 58, 56 in the substrate 44. The seals 98, 100 form a seal between the closeout panel 42 and the substrate 44; in addition, they provide a seal for air diffusers (not shown) that can be attached to the door panel. In addition to the air duct seals 98, 100, a portion of the second shot forms a water seal 102 disposed around a perimeter of the closeout panel 42. The seal 102 helps to ensure that water does not enter between the closeout panel 42 and the substrate 44.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method for producing a vehicle trim component including a two-shot polymeric closeout panel and a substrate having at least one opening therein, the method comprising:
injection molding a first portion of the closeout panel, including at least one cavity forming structure configured to cooperate with a corresponding opening in the substrate, thereby forming a corresponding cavity that is accessible through the substrate; and
injection molding a second portion of the closeout panel covering at least some of the at least one cavity forming structure.

2. The method of claim 1, wherein the first portion of the closeout panel is injection molded in a core and a first cavity of a mold, and the second portion of the closeout panel is injection molded in the core and a second cavity of the mold.

3. The method of claim 2, further comprising:
injection molding a first portion of the substrate in the core and the first cavity of the mold; and
injection molding a second portion of the substrate in the core and the second cavity of the mold, the second portion of the substrate covering at least some of the first portion of the substrate.

4. The method of claim 3, further comprising rotating the mold core after the first portion of the substrate and the first portion of the closeout panel are molded.

5. The method of claim 1, wherein the first portion of the closeout panel is molded from polypropylene, acrylonitrile butadiene styrene, or polycarbonate acrylonitrile butadiene styrene.

6. The method of claim 1, wherein the second portion of the closeout panel is molded from a thermoplastic elastomer, a thermoplastic polyolefin, or a thermoplastic vulcanizate.

7. The method of claim 1, wherein the first portion of the closeout panel includes at least one energy absorbing structure.

8. A method for producing a vehicle door panel including a two-shot polymeric closeout panel and a substrate having at least one opening therein, the method comprising:
injection molding a first portion of the closeout panel, including at least one cavity forming structure configured to cooperate with a corresponding opening in the substrate, thereby forming a corresponding cavity that is accessible through the substrate; and
injection molding a second portion of the closeout panel covering at least some of the at least one cavity forming structure.

9. The method of claim 8, wherein injection molding the first portion of the closeout panel includes molding therein at least one of a door latch structure, an armrest structure, a coin holder structure, a map pocket structure, an energy absorbing structure, an air duct, and an audio speaker structure.

10. The method of claim 8, wherein injection molding the second portion of the closeout panel includes molding thereon at least one seal configured to cooperate with the substrate to form a seal between the closeout panel and the substrate.

11. The method of claim 10, wherein the first portion of the closeout panel is injection molded in a core and a first cavity of a mold, and the second portion is injection molded in the core and a second cavity of the mold.

12. The method of claim 11, further comprising:
injection molding a first portion of the substrate in the core and the first cavity of the mold; and
injection molding a second portion of the substrate in the core and the second cavity of the mold, the second portion of the substrate covering at least some of the first portion of the substrate.

13. The method of claim 12, further comprising rotating the mold core after the first portion of the substrate and the first portion of the closeout panel are molded.

14. The method of claim 12, wherein injection molding the first portion of the substrate includes molding at least one of an armrest structure, a map pocket opening, a door latch opening, an audio speaker opening, and an air duct opening.

15. The method of claim 14, wherein injection molding the second portion of the substrate includes molding a bolster over a portion of the first portion of the substrate.

16. A two-shot polymeric vehicle trim component, comprising:
a substrate including at least one opening therein; and
a closeout panel including first and second portions, the closeout panel being configured to cooperate with the substrate to form the trim component, the first portion including at least one cavity forming structure configured to cooperate with a corresponding opening in the substrate, thereby forming a corresponding cavity that is accessible through the substrate, the second portion covering at least some of the at least one cavity forming structure.

17. The trim component of claim 16, wherein the first portion of the closeout panel includes, integrally molded therewith, at least one of a door latch structure, an armrest structure, a coin holder structure, a map pocket structure, an energy absorbing structure, an air duct, and an audio speaker structure.

18. The trim component of claim 16, wherein the second portion includes molded thereon at least one seal configured to cooperate with the substrate to form a seal between the closeout panel and the substrate.

19. The trim component of claim 16, wherein the substrate includes first and second portions, the first portion of the substrate including, integrally molded therein, at least one of an armrest structure, a map pocket opening, a door latch opening, an audio speaker opening, and an air duct opening.

20. The trim component of claim 19, wherein the second portion of the substrate includes a bolster molded over a portion of the first portion of the substrate.
